(19) United States
(12) Patent Application Publication
(10) Pub. No.: US 2023/0049144 A1
(43) Pub. Date: Feb. 16, 2023

(54) PROACTIVELY PROTECTED PROCESSING SYSTEM AND METHOED FOR CYBERSECURITY

(71) Applicant: Yong-Kyu Jung, Fairview, PA (US)

(72) Inventor: Yong-Kyu Jung, Fairview, PA (US)

(21) Appl. No.: 17/887,234

(22) Filed: Aug. 12, 2022

Related U.S. Application Data
(60) Provisional application No. 63/233,225, filed on Aug. 14, 2021.

(51) Int. Cl. G06F 21/54; G06F 21/55; G06F 21/31

(52) U.S. Cl. CPC G06F 21/54; G06F 21/554; G06F 21/31

(57) ABSTRACT

A proactively protected (P2) processing system and method is invented for stopping the cyber-attacks from malicious usages of computing systems. The invention is applicable to eliminate the roots of the cyber-threats before a successful cyber-incident. Thereby, demand for resilient computing systems to survive a cyber-incident will be disappeared. Any recovery act and information loss is not happened. The invention dynamically switches a plurality of instruction sets at random or scheduled time for determining authorized operations with code compatibility. Therefore, a P2 processing system and method can detect and delete only unauthorized operations before being executed while executing authorized operations.

### TECHNICAL FILED OF THE DISCLOSURE

The invention relates creating a proactively protected (P2) processing system for preventing unauthorized persons from malicious usages of P2 processing systems. The invention relates also permitting only authorized persons or computing systems to use protected information that is generated and modified by the invented P2 processing unit hardware in a P2 processing system unlike computing systems in prior arts preventing unauthorized persons or computing systems from accessing the computing systems.

The invention relates compiling unprotected instructions (UIs) used in an unprotected system. The invention also relates performing P2 compilation in which an executable program is compiled to produce a P2 instruction (P2I) code and a segmented compatible instruction (SCI) code.

The invention relates to generate a plurality of different formats of the P2 instruction (P2I) sets by relocating a single or plurality of bits in a single or plurality of different fields in a P2I set to the same or different locations in the P2I set.

### BACKGROUND OF THE DISCOLOSURE

The present invention generally relates performing proactive protections of P2 processing systems. More specifically, a single or plurality of processors equipped in a computer system is transformed to a single or plurality of P2 processors in order for authorized persons to securely utilize a computer system.

The present invention generally relates also permitting only authorized persons or computing systems to use protected information that is generated and modified by the invented P2 processing unit hardware in a P2 processing system.

The present invention generally relates compiling UIs and performing P2 compilation in which an executable program is compiled to produce a P2I code and a SCI code, wherein the P2I code and the SCI code are for proactively protecting information in computing systems and the computing systems themselves and for producing compatible execution results of the executable program, wherein an executable program comprises a single or plurality of UIs. The P2 compilation produces a single or plurality of P2I sets from an UI set used in the unprotected systems and the executable program, wherein a P2I set comprises a plurality of P2Is transformed from the UIs used in the executable program. More specifically, the P2 compilation determines (1) how many a single UI or a plurality of consecutive UIs is assigned to a P2I for enhancing code security by increasing probability of the possible combinations of different P2Is generated from the single UI or the plurality of consecutive UIs, and (2) how many SCIs are generated from the executable program for controlling different levels of code protections and performance and resources, including instruction memory size, according to characteristics of the executable program and the different types of computing systems.

The invention generally relates to generate a plurality of different formats of the P2I sets by relocating a single or plurality of bits in a single or plurality of different fields in a P2I set to the same or different locations in the P2I set. A P2I set provides compatible execution results regardless of which P2I set is used for the P2 compilation of the same executable program.

The invention generally relates creating a P2 instruction (P2I) formatter 6 to generate a shuffled P2I 64 of a P2I by shuffling an identification field and a single or plurality of other fields in the P2I in a random or predefined manner. A shuffled unique identification field is generated by a bit shuffling logic according to random bit-shuffling transformation data and bit shuffling metadata, wherein the random bit-shuffling transformation data is a single or plurality of indexes selected in a random or predefined manner for shuffling a single or plurality of bits in a single or plurality of fields of the P2I, wherein the bit shuffling metadata provides description and information about a single or plurality of indexes for shuffling order of bits and/or of P2I fields, and other information and description of the bits and the P2I fields that are shuffled.

The invention relates allocating the generated P2Is and SCIs to P2I memory and fetching the shuffled P2Is 64 and/or the SCIs in serial or parallel with P2 instruction (P2I) memory system if necessary, wherein the P2I memory system is to a single or plurality of the shuffled P2Is 64 and/or SCIs to a single or plurality of the unprotected processors in the P2 processing unit hardware for fetching, decoding, and scheduling a single or plurality of the shuffled P2Is 64 and/or the associated SCIs. In particular, each fragmented P2I and associated fragmented SCIs generated by P2 compilation with the P2I set if a plurality of the fragmented SCIs is fetched concurrently. Therefore, the fragmented P2I and the associated fragmented SCIs are allocated to different locations for parallel accessing. Thus, additional instruction fragmentation provides the enhanced probability of randomness for higher levels of cybersecurity.

The invention relates recursively reformatting a plurality of instruction sets via code transformation between computing systems. The invention also relates securely exchange executable programs and information between authorized computing systems with the P2s according to the transforming rules and distributing orders and schedules for transformation cycle.

The invention relates monitoring P2I protecting resource map and management. The invention also relates configuring a single or plurality of computing systems for evaluating the executable programs and information management. The invention also relates configuring and identifying the management and monitoring policies and protocols between the same and different types of computing systems. The invention relates distributing proactive executable programs and information and then archiving or discarding final disposition of the proactive executable programs and information.

### PROBLEMS OF THE ART

In general, information in computer systems is ciphered to prevent from malicious usages. For instance, elliptic curve cryptography [1], asymmetric-RSA [2], symmetric-Advanced Encryption Standard, and other encryption techniques are widely used.

An instruction converting apparatus is presented in U.S. Pat. No. 6,047,368 [3] utilizes the translation and grouper circuits. The translation circuit transforms simpler forms of new instructions from old instructions. Whenever an instruction is fetched to an instruction cache, instructions are grouped according to types of the instructions and then the grouped instructions are concurrently issued and executed for code compatibility. However, this invention still requires the same or more instruction caches because the bit-length of instructions is not reduced.

An instruction converting method and apparatus is presented in U.S. Pat. No. 7,269,715 [4]. A current set of instructions received as part of a group, including a prior set of instructions, is distinguished by using a history data structure. A critical path is recognized to break apart incoming instructions into special groups or formations in the approach while instructions are fetched between an instruction cache and a memory. Finally, the converted instructions, including a converting indication, are used by the execution units. Grouper circuit and translation circuit are specifically invented to issue the converted instructions to the execution units.

Simultaneously converting and issuing instructions at the same clock cycle for execution is claimed in U.S. Pat. No. 5,509,130 [5]. After decoding a sequence of instructions, an instruction control unit detects operands cascading from one instruction to another instruction. Instructions, then, are packed according to exclusion rules reflecting characteristics of the resources and structure of the target processor. This invention, however, not only requires maintaining at least the same size of the instruction cache, but also involving branch prediction and resolution units due to the runtime conversion.

Information stored in a computer is more valued than computer itself. Information security techniques have been evolving to various directions from one origin, “security software.” (1) Blocking computers from unauthorized persons is the most popular security solution. (2) Encrypting and decrypting of valuable information is to prevent malicious usage from unauthorized persons. The crypto variable and other information need to be shared with the authorized users. In general, the encryption also needs to be less susceptible. (3)

Other encryption systems, including symmetric-advanced encryption standard, asymmetric-RSA, or elliptic curve cryptography, are used different key sizes. (4) Antivirus software/internet security program is to prohibit malicious programs from being admitted into computers. (5) Data

Encryption Standard offers an encryption alongside of existing security technologies. Other cybersecurity related activities include: Security services, infrastructure protection, network security equipment, identity access management, integrated risk management, data security, consumer security software, and application/cloud/etc. The approaches in prior arts are vulnerable once unauthorized persons can access computers to obtain secured data and run malicious programs to control the computers. Thus, CPUs which do most operations in computers do their operations in a passive manner.

The roots of the threats have been growing. Some of security solutions include: (1) encryption-based cryptographic key management and protocol technique (e.g., key management services from Amazon/Google/etc.), (2) the hardware-assisted identity and credential protection techniques (i.e., biometric sensor-based techniques), (3) hardware security techniques to generate an architecture layer and store personal data and credentials encrypted in a separate location (e.g., Qualcomm's security processing unit) [6], but this technique introduces performance overheads and protection limitations for frequently accessed applications, (4) hybrid techniques for embedded systems (e.g., CoreGuard [7-8]) prevent software vulnerabilities against entire classes of network-based attacks with a co-processor system and a metadata generation compiler for generating software in target embedded systems.

The P2 processing system is to prevent unauthorized persons or computers from unauthorized accesses and malicious usages of computer systems by (1) transforming unprotected processors to P2 processing unit hardware; (2) dynamically generating a plurality of unique P2I sets and randomly switching one of the P2I sets at random or scheduled time to detect and delete a single or plurality of unauthorized executable programs and access secured information; and (3) authenticating each of the executable programs and information according to the authorized P2I set by a single or plurality of the P2 processing units hardware.

### SUMMARY OF THE DISCLOSURE

The boundaries of a machine language for a processor are rigidly established upon manufacturing. Since a processor utilizing an instruction set is unlikely to last long among rapidly advancing technologies, and valuable time and energy are lost due to the use of outmoded forms to express new ideas or demands. To overcome such limitations and inefficiencies, new instructions are added to the inst-set for greater adaptability to support swiftly evolving applications. Machine language also has another feature that can be applicable for cybersecurity if a group of authorized processors can switch to use the same machine language whenever needed.

The invention relates to a proactive cybersecurity offered by recursively self-reformatting a plurality of instruction sets whenever necessary. Processors can dynamically reformat instruction sets to perform secured operations with only a matched instruction set after identifying an instruction set. Thus, a machine language code received is evaluated and identified as an executable code written in currently identified instruction set. If any machine code is compiled in the currently identified instruction set, the code is executed without error. Otherwise, the processor can detect unidentified instructions to delete the code.

The invention relates to a P2 processing system that provides proactive protection to unprotected processors in the P2 processing unit hardware in a physical layer for cybersecurity. This disruptive concept replaces a reactive nature of existing software-based security approaches with P2 computers that remove a root of threats.

There has thus been outlined, rather broadly, some of the features of the invention in order that the detailed description thereof may be better understood, and that the present contribution to the art may be better appreciated. Additional features of the invention will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to design reformatted instruction sets by a compatible or an original instruction set that is transformed by shuffling bits within the assigned length of instructions by encoding logic as per the transformation rule (i.e., random order of bits) and distribution schedule (i.e., random interval to switching inst-sets).

An object is to generate a secure code from instructions compiled by existing compiler by a P2 compiler that can segment as per the segmentation modes including (1) a desired level of security, (2) a desired level of performance, and (3) mixed features of security and performance as an optimization mode. With the selected segmentation mode, the number of instructions segmented in a P2I is randomly determined. These features contribute to enhance performance.

An object is to customize the format, type of a P2I, memory location of the first SCI in the P2I, a single or plurality of SCIs associated in the P2I, based on the needs. More specifically, a P2I compiles a plurality level of loops by recursively operating the instruction compilation. Various unprotected instruction streams are identified and converted to a pair of a P2I and a single or plurality of SCIs. An instruction stream can be converted to a plurality of P2Is for the parallel fetch.

Another object is to dynamically respond a busting request to migrate another format of instruction set in a P2I formatter that generates bit orders of P2Is on the fly with random bit-shuffling transformation data to configure a bit shuffling logic and produce associated bit-shuffling metadata, including segmentation mode, orders of bits, authentication information, expiration time, etc. This bit and/or field shuffling metadata is used for generating a different format of a P2I.

Another object is to provide locations of P2I code and SCI code in instruction memory systems and P2 and non-P2 data in data memory systems to an unprotected processor in a P2 processing system.

Another object is to prevent unauthorized persons and/or machines from unauthorized accesses and malicious usages of computing systems by a single or plurality of P2 processing units, P2Is for distinguishing an authorized code and data from an unauthorized code and data, P2I set transformation compilation for dynamically recompiling a current authorized code to generate a P2I code and a SCI code, and P2 processing unit hardware for swiftly resuming scheduled tasks, including detecting, disabling, and deleting an unauthorized code upon admitting into the P2 processing unit and executing only an authorized code comprising of the P2I code and the SCI code and P2 information and producing equal or compatible outcomes. More specifically, the P2I set transformation compilation identifies random instruction segments in a SCI code as per the selected segmentation mode, which represents a desired level of security, a desired level of performance, and mixed features of security and performance, transforms the identified segments to the SCI code by reformatting segments as per the identified P2I set, generates decoding information to decode shuffled P2Is according to the P2I set. More specifically, a series of consecutive P2 compilation is to create a single or plurality of SCIs from every unprotected instruction (UI) stream in an unprotected executable code when an authorized identification is accepted, wherein the P2 compilation continues until the last segment of the unprotected executable code is compiled. The transformation information is also used for dynamic retransformation of the P2I formatter hardware to shuffle bits of each P2I to recover bit-orders of the P2I.

An object is to create a P2 computing system with a single or plurality of unprotected processors to execute P2Is and SCIs delivered from the P2 instruction (P2I) scheduler via the P2 instruction (P2I) decoder and the P2 instruction (P2I) fetcher, wherein the P2Is and the SCIs are allocated into the separately or concurrently accessible P2I memory system comprising of the P2 and the SC memories and caches. More specifically, the P2 computing system forwards addresses of the authorized SCIs to the P2I fetcher for fetching authorized SCIs in order, decodes the shuffled P2Is fetched from the P2I fetcher and the P2I cache and memory according to decoding information generated from the P2I set with a P2I decoder, transmit authorized and shuffled P2Is to the P2I scheduler if decode results of the shuffled P2Is indicate that the shuffled P2Is are the authorized and shuffled P2Is, otherwise discard the shuffled P2Is from the P2I decoder and transmit the decode results of the unauthorized and shuffled P2Is to the P2I cache and memory, and holds the decode results of the authorized and shuffled P2Is in the P2I decoder until the P2I scheduler receives the decode results of the authorized and shuffled P2Is, wherein the shuffled P2Is are the P2Is compiled from a single or plurality of UIs by the P2 compiler according to the P2 instruction format followed by shuffling the P2Is by the P2 instruction formatter.

Another object is to fetch both of authorized P2Is and unauthorized P2Is from the P2 caches with the P2I fetcher until a single or plurality of branch prediction results are forwarded to the P2I fetcher. More specifically, the P2I fetcher fetches both of authorized SCIs and unauthorized SCIs in order upon receiving addresses of the authorized SCIs and the unauthorized SCIs from the P2I decoder. The P2I fetcher fetches certain types of the P2Is along with the SCIs for code compatibility via the P2I fetcher, wherein the certain types of the P2Is are compiled according to different segmentation modes, wherein the different segmentation modes include a desired level of security, a desired level of performance, and (3) mixed features of security and performance as an optimization mode.

Another object is to deliver the SCIs scheduled, including the P2 flow-control instructions (e.g., conditional branches) from the P2I scheduler if the flow-control instructions are predicted, wherein the P2I scheduler delivers P2Is and/or SCIs to a single or plurality of unprotected processors.

Another object is to store private information and credentials in the protected locations of data memory, which only can be accessed by executing an authorized code that is a key to access data in the locations. The other data file is also protected by reformatting with an authorized instruction set. A protected data file can be created along with an encryption identification of the P2I set for decrypting the data file when reading data from the file after being protected.

Another object is to convert an unprotected code and data to a protected code and data. An unprotected code, such as application and system software written in an instruction set, is compiled by the P2 compilation at random time intervals. The P2 compilation generates P2I codes and SCI codes. The protection monitor handles the operations related to the protecting resource mappings and management alongside the P2 compilation and the P2 data memory system.

More specifically, a multi-processor computing system is transformed to a P2 version for securely and remotely being utilized, instead of only blocking accesses of a computing system. The invention increases randomness of P2Is and security capability by reducing control signals and other data encapsulation. Vast majority of security issues can be resolved in a proactive manner, which eliminates roots of threads as well as prevents rapid propagations of intentional infections by persons with the protection monitoring & management method.

An object is to design a protected code and data management, acquisition, and sharing between P2 computing systems in a hierarchical security management and monitoring over communication networks by a plurality of the P2 computing systems that securely exchange a machine code and data must be synchronized with the transforming rules and distributing orders and schedules for every transformation cycle.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called, however, to the fact that the drawings are illustrative only, and that changes may be made in the specific construction illustrated and described within the scope of this application.

In this patent document, the terms “include” and derivatives thereof mean inclusion without limitation.

### BRIEF DESCRIPTION OF THE DRAWINGS

A more complete understanding of embodiments of the disclosure will be apparent from the detailed description taken in conjunction with the accompanying drawings in which:

FIG. 1 is a diagram showing one embodiment of the proactively protected (P2) processing for a P2 computing system including a P2 compiler and a P2 instruction (P2I) formatter to generate random bit-order of P2Is, wherein the P2 compiler generates a P2 instruction (P2I) code including P2Is compiled from unprotected instructions (UIs) compiled by a conventional compiler for an unprotected processor and a segmented compatible instruction (SCI) code including SCIs compiled from the P2Is, wherein the P2Is are designed in a P2I format comprises three fields, including a type of a P2I, a memory location of the first SCI in the P2I, and a single or plurality of SCIs associated in the P2I, wherein the UIs, the P2Is, and the SCIs are stored in an UI memory, a P2I memory, and a SCI memory, respectively, wherein the P2I formatter comprises a bit shuffling logic interfaced to a random bit-shuffling transformation data and a bit and/or field shuffling meta data for generating a shuffled P2I of a P2I by shuffling an identification field and a single or plurality of other fields in the P2I in a random or predefined manner, wherein the shuffled P2I includes a shuffled unique identification field that is generated by the bit shuffling logic according to the random bit-shuffling transformation data and the bit and/or field shuffling metadata, wherein the random bit-shuffling transformation data is a single or plurality of indexes selected in a random or predetermined manner for shuffling bits in a single or plurality of fields of the P2I, wherein the bit and/or field shuffling metadata provides information about a single or plurality of indexes for shuffling order of bits and/or of fields, and other information of bits and/or fields that are shuffled.

FIG. 1 is also a diagram showing one embodiment of the compilation method of P2 instruction (P2I) generation from UIs and SCI generation from the P2Is and the code allocation method, and more specifically, an instruction memory transformation method to protect a P2 instruction (P2I) memory system if unprotected processors need to fetch shuffled P2Is and SCIs in parallel.

FIG. 2 is a diagram showing one embodiment of a P2 processing system including a P2I memory system and a P2 processing unit hardware for detecting, disabling and/or deleting unauthorized P2Is and/or unauthorized SCIs and delivering only authorized P2Is and/or authorized SCIs to an unprotected processor, wherein the P2I memory system including a P2 instruction (P2I) cache and memory and a SC instruction (SCI) cache and memory for storing and P2Is and SCIs and delivering authorized P2Is and/or authorized SCIs to the unprotected processor, wherein the P2 processing unit hardware including an unprotected processor, a P2 data memory system, and a P2 hardware comprising a P2 instruction (P2I) fetcher, a P2 instruction (P2I) decoder, and a P2 instruction (P2I) scheduler for detecting, disabling and/or deleting unauthorized P2Is and/or unauthorized SCIs, producing compatible results of authorized executable codes, and storing and utilizing P2 and/or non-P2 data processed by the unprotected processor.

FIG. 2 is also a diagram showing one embodiment of a P2 instruction (P2I) set transformation compilation including a P2 compilation to compile executable programs compiled for an unprotected system, produce P2I codes and SCI codes, and generate a plurality of P2I sets for P2I code compilation; a protection monitor is to handle a protecting resource mappings and management alongside the P2 compilation and the P2 data memory system and provide inputs to the P2I codes and the SCI codes for increasing randomness of P2Is and security capability by reducing control signals and other data encapsulation.

FIG. 3 illustrates a P2I and a SCI generation and allocation processes, including a P2I set transformation compilation for formatting, fragmenting, and allocating P2Is and SCIs, which are compiled from an unprotected machine language code compiled by unprotected compilers with a target instruction set, the allocation process of P2Is and SCIs for allocating the P2Is and the SCIs to P2 and SC instruction caches and memories for parallel fetching to a plurality of the unprotected processors, a P2 compilation for identifying a single or plurality of instructions in the unprotected machine language code for fragmenting the P2Is and generating a plurality of P2Is and addresses to allocate the P2Is in the P2I memory and a plurality of SCIs and addresses to allocate the SCIs in the SCI memory or a P2I and address, and for fragmenting a plurality of the SCIs and generating a plurality of fragmented SCIs and addresses to allocate the fragmented SCIs, or iterate the P2 compilation, and then for allocating the P2Is and the SCIs generated to the P2I memory and to the SCI memory, respectively.

### DETAILED DESCRIPTION OF EXAMPLE EMBODIMENTS

Various embodiments of systems and methods are disclosed for implementing a proactively protected (P2) instruction set transformation compilation and a P2 processing system for operating as a P2 computing system according to a plurality of cybersecurity operations.

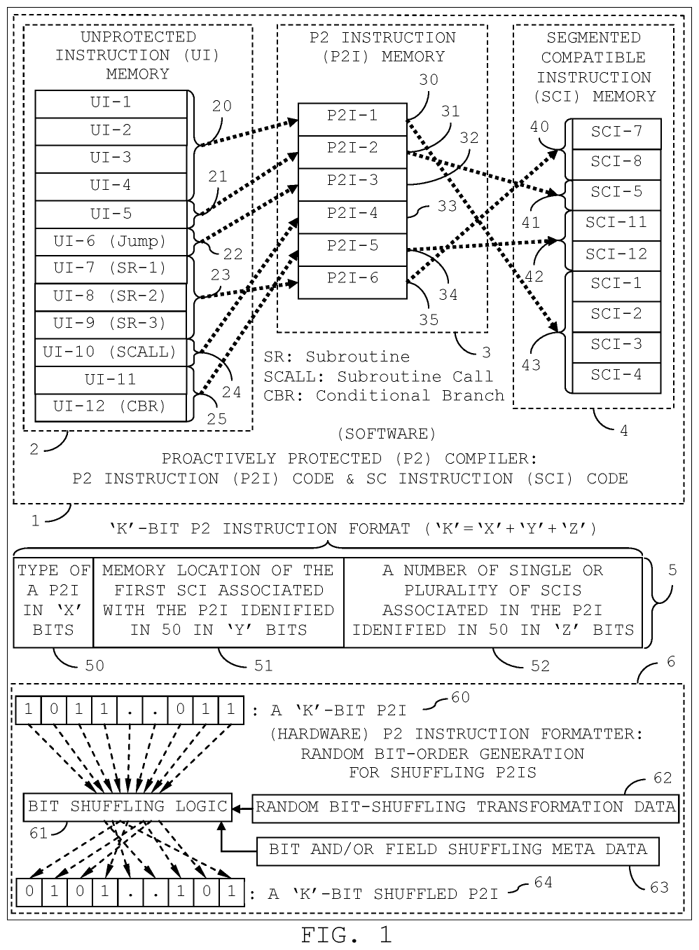

FIG. 1 is a diagram showing one embodiment of the proactively protected (P2) processing software and hardware for a P2 computing system including a P2 compiler 1 as software and a P2I formatter 6 as hardware to generate random bit-order of P2Is, such as P2I-1 30, P2I-2 31, P2I-3 32, P2I-4 33, P2I-5 34, and P2I-6 35.

In one embodiment, the P2 compiler operates to (1) generate the P2Is 30, 31, 32, 33, 34, 35 stored in a P2I memory 3 via the P2I formatter 6 from unprotected instructions (UIs) 20, 21, 22, 23, 24, 25 compiled by a conventional compiler for an unprotected processor 98 and stored in an UI memory 2 and (2) generate the SCIs 40, 41, 42, 43 from the P2Is compiled and shuffled, wherein the SCI 40 including SCI-7 and SCI-8, the SCI 41 including SCI-5, the SCI 42 including SCI-11 and SCI-12, and the SCI 43 including SCI-1, SCI-2, SCI-3, and SCI-4, are generated and stored in a SCI memory 4. The P2 compiler 1 also segments as per segmentation modes, including one of a plurality of desired security levels, one of a plurality of desired performance levels, one of a plurality of optimization levels which counts on both security and performance levels, and other desired features used, but not limited.

The P2compiler 1 (3) produces a P2I and a plurality of SCIs from a plurality of UIs 20, UI-1, UI-2, UI-3, UI-4 and UI-5, wherein the SCIs, SCI-1, SCI-2, SCI-3, and SCI-4 43, must be executed by the unprotected processors 98 in order for saving entries of the P2I memory 3, or (4) produces a plurality of P2Is, P2I-1 30 and P2I-2 31, and a plurality of SCIs, SCI-1, SCI-2, SCI-3, and SCI-4 43 and SCI-5 41, the P2I-1 30 from a plurality of UIs 20, UI-1, UI-2, UI-3, and UI-4 for generating distinguished P2 compilation results from the results of other computing systems for the code security, (5) compiles the UI-5 21 separated from the consecutive UIs, UI-1, UI-2, UI-3, and UI-4, to another P2I as P2I-2 31 due to the different segmentation mode, (6) translates an unconditional flow control UI, UI-6 (Jump) 22, to P2I-3 32, which is no longer executed by the unprotected processor 98 without causing any code compatibility in the P2 computing system, (7) compiles the consecutive UIs 23, UI-7 (SR-1), UI-8 (SR-2), and UI-9 (SR-3), in a subroutine including a subroutine return UI, the UI-9 (SR-3), to a P2I-6 35 and a plurality of SCIs, SCI-7 and SCI-8 40, wherein the consecutive UIs in the subroutine is compiled with or without the P2I-6 35, wherein the P2I-6 35 compiled from the subroutine return UI, UI-9 (SR-3), is not executed by the unprotected processors 98 and is not necessary to store in the P2I memory system 87, (8) compiles the consecutive UIs in an interrupt service routine or an exception service routine including a interrupt service routine return UI or an exception service routine UI a P2I and a plurality of SCIs, wherein the consecutive UIs in the interrupt service routine or the exception service routine is compiled with or without the P2I, wherein the P2I compiled from the interrupt service routine return UI or the exception service routine UI is not executed by the unprotected processors 98 and is not necessary to store in the P2I memory system 87 (9) compiles an UI, a subroutine call instruction, to a P2I, wherein the P2I compiled from the subroutine return UI is not executed by the unprotected processors and is not necessary to store in the P2I memory system, (10) compiles an UI, UI-10 (SCALL), a subroutine call instruction, to a P2I, P2I-4 33, wherein the P2I compiled from the subroutine call UI is executed by the unprotected processors but not necessary to produce an associated SCI and not store in the SCI cache and memory 89 in the P2I memory system 87, (11) also compiles an UI, an interrupt service routine call instruction or an exception service routine call instruction, to a P2I, wherein the P2I compiled from the interrupt service routine call or the exception service routine call UI is executed by the unprotected processors 98 but not necessary to produce an associated SCI and not store in the SCI cache and memory 89 in the P2I memory system 87, (12) compiles consecutive UIs, UI-11 and UI-12 (CBR), including a conditional branch instruction, UI-12 (CBR), to a P2I, P2I-5 34, and consecutive SCIs, SCI-7 and SCI-8 40, which are executed by the unprotected processors 98 for performing assigned conditional branch operations, wherein the last UI compiled, UI-12 (CBR), is a conditional branch instruction, which may use a branch prediction unit for predicting branch operation status.

The P2 compiler 1 also (13) allocates a plurality of the P2Is generated, P2I-1 30, P2I-2 31, and P2I-5 34, to the P2I memory 3 for fetching the associated SCIs, SCI-1, SCI-2, SCI-3, and SCI-443, SCI-5 41, and SCI-11 and SCI-12 42, from the SCI memory 4, (14) allocates a single or plurality of additional P2Is, P2I-3 32, to the P2I memory 3 for performing the unconditional flow control operations without accessing SCIs by the unprotected processor 98, (15) generates different number of the P2Is according to one of the segmentation modes selected, but must be allocated in the same order of a single or plurality of the UIs compiled by the conventional compiler. Unlikely, the P2 compiler 1 allocates (a) a single or plurality of the SCIs, including SCIs 43, including SCI-1, SCI-2, SCI-3, and SCI-4, generated from a consecutive plurality of UI, the UI-1, UI-2, UI-3, and UI-4 20, or a SCI 41, SCI-5, is generated from a single UI, UI-5 21, respectively, (b) a plurality of the SCIs 42, including SCI-11 and SCI-12 42, generated from a plurality of UIs including a conditional flow control UI, the UI-11 and UI-12 (CBR) 25, and (c) a single or plurality of the SCIs 40, including SCI-7 and SCI-8, generated from a single or plurality of UIs in a subroutine, the UI-7 (SR-1), UI-8 (SR-2), UI-9 (SR-3) 23, to a plurality of different entries, which are not overlapped each other in the SCI memory 4, in different order of the associated the P2Is stored in the P2I memory 3. The P2 compiler 1 compiles a plurality of UIs in an executable code to a plurality of P2Is and a plurality of associate SCIs, which produce compatible results of a plurality of the UIs with a single or plurality of the unprotected processors 98, wherein a plurality of the P2Is and a plurality of the associate SCIs executed can be a few number of the UIs to increase performance, reduce processing energy, while securing authorized executable code by distinguishing the UI code compiled for common or unprotected usage from the P2I code and the SCI code compiled for authorized protected usage with a single or plurality of authorized computing systems. The presented P2 compiler 1 is not limited in its application to the details of construction or to the arrangements of the components set forth in the above description or illustrated in FIG. 1.

In one embodiment, a P2 instruction (P2I) format operates to design (1) a plurality of P2I bit-formats comprising of a plurality of fields, including an ‘X’-bit type of P2I 50, a ‘Y’-bit memory location of the first SCI in the P2I 51, and a ‘Z’-bit single or plurality of SCIs associated in the P2I 52, wherein ‘X’, ‘Y’, ‘Z’, and ‘K’ are positive integers, (2) types of P2Is 50 including a type of unconditional or conditional flow control, a subroutine call or return, subroutine, and other different types of P2Is found in prior arts, (3) memory location of the first SCI 51 associated with the P2I identified in the field 50 after the P2I code compilation, and (4) a number of single of plurality of SCIs 52 associated with the P2I identified in the field 50. The P2I format also operates to change the P2I format 5 in the specific instruction set and/or the processor designed within the scope of target applications, and do not limit the P2I format 5 in its bit-length of the fields, orders of the fields, and a single or plurality of other fields to the details of construction or to the arrangements of the bits and orders set forth in the above description or illustrated in FIG. 1.

In one embodiment, a P2I formatter as a hardware component operates to generate bit orders of P2Is compiled through the P2I code compilation on the fly in order to dynamically respond a busting request to migrate another format of an instruction set, include a bit shuffling logic 61 interfaced to a hardware component containing random bit-shuffling transformation data 62 (1) to configure the bit shuffling logic 61, (2) to translate current P2I format to another format within a single of plurality of instruction cycles, and (3) to produce associated bit and/or field shuffling meta data 63, contain bit and/or field shuffling meta data 63 for generating a ‘K’-bit shuffled P2I 64 of a P2I by shuffling bits of the P2I in a random or predetermined manner with another hardware component, utilize random bit-shuffling transformation data to configure the bit shuffling logic 61, which translates the currently used P2I format to another P2I format within a single or plurality of instruction cycles and produces associated bit and/or field shuffling metadata with the bit shuffling logic 61, wherein the bit and/or field shuffling metadata includes (1) segmentation mode, (2) orders of bits, (3) authentication information, (4) expiration time, etc., wherein the random bit-shuffling transformation data 62 is a single or plurality of indexes selected in a random or predetermined manner for shuffling a single or plurality of bits in a single or plurality of fields of the P2I, generate a different format of a P2I with the bit and/or field shuffling metadata 63, provide description and information about a single or plurality of indexes for shuffling order of bits and/or of fields with the bit and/or field shuffling metadata 63, utilize other information and description of bits and/or fields that are shuffled in a P2I, and do not limited in its application to the details of construction or to the arrangements of the components set forth in the above description or illustrated in FIG. 1.

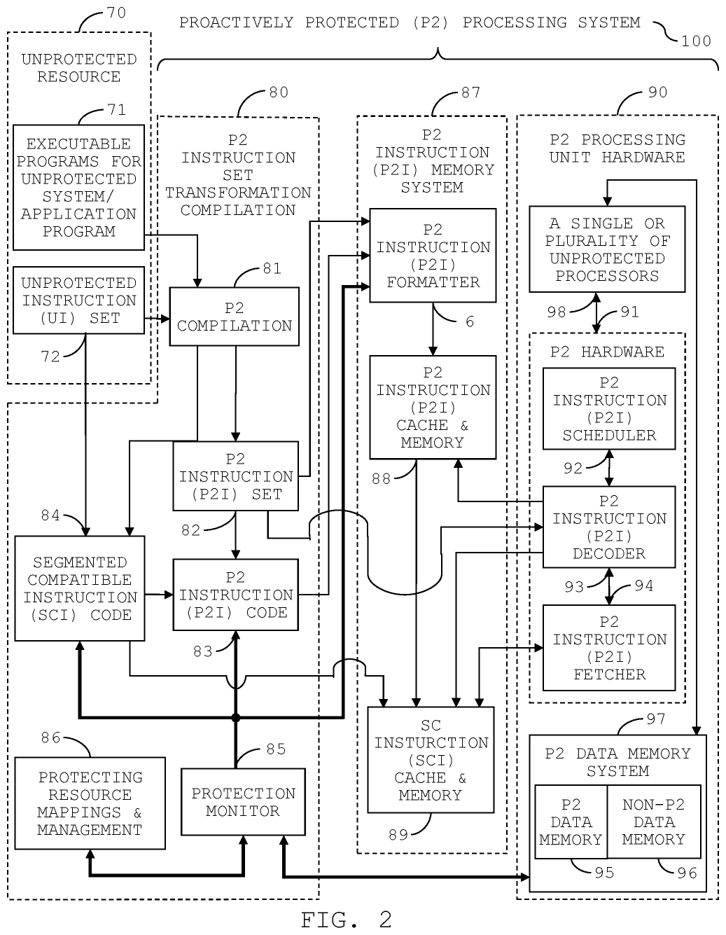

FIG. 2 is a diagram showing one embodiment of a proactively protected (P2) processing system 100 comprising a P2 processing unit hardware 90, a P2 instruction (P2I) memory system 87 as hardware, and a P2 instruction (P2I) set transformation compilation 80 as software.

The P2 processing system 100 performs proactive protections of the P2 processing systems 100, prevents unauthorized persons from malicious usages of the P2 processing systems 100, and provides proactive protection of a single or plurality of unprotected processors 98 in a physical layer for cybersecurity.

The P2processing system 100 permits only authorized persons or computing systems to use protected information that is generated and modified by the P2 processing unit hardware 90, and detects, disables, and/or deletes unauthorized P2 instructions (P2Is) and/or SC instructions (SCIs), and delivers only authorized P2Is and/or SCIs to the unprotected processors 98.

The P2 processing system 100 also transforms a plurality types of the unprotected processors 98, including central processing units (CPUs), mobile application processors (APs), digital signal processors (DSPs), graphic processing units (GPUs), microcontroller units (MCUs), and other embedded or application specific processors being used in reactively protected or unprotected computing systems, to a plurality types of proactively protected processing unit hardware.

The P2 processing system 100 dynamically generates a plurality of unique P2I sets 82, randomly switches one of a plurality of the P2I sets 82 at random or scheduled time to detect and delete unauthorized executable program, and accesses secured information and authenticate executable program and information according to authorized P2I set 82 by a single or plurality of P2 processing units hardware.

The P2I set transformation compilation 80 in the P2 processing system 100 dynamically recompiles a current authorized code to generate a P2 instruction (P2I) code 83 and a segmented compatible instruction (SCI) code 84, identifies random instruction segments in the SCI code 84 as per the selected segmentation mode, which represents a desired level of security or performance, transforms the identified segments to the SCI code 84 by reformatting segments as per the identified P2I set 82, generates configuration information of P2Is in the P2I set 82 to decode the P2Is, creates a single or plurality of the SCIs from every unprotected instruction stream in an unprotected executable code 71 when an authorized identification is accepted, continues a series of consecutive P2 compilation until the last segment of the unprotected executable code 71 is compiled, uses transformation information for dynamic retransformation of a P2 instruction (P2I) formatter 6 to shuffle bits of each P2I to recover bit-orders of the P2I, compiles executable programs compiled for an unprotected system and/or an application program 71 with an unprotected instruction (UI) set 72, produces the P2I codes 83 and the SCI codes 84, generates a single or plurality of the P2I sets 82 for P2 compilation 81, handles operations related to a protecting resource mappings and management 86 alongside the P2 compilation 81 and a P2 data memory system 97 using a protection monitor 85.

The P2I set transformation compilation 80 in the P2 processing system 100 also provides inputs to the P2I codes 83 and the SCI codes 84 for increasing randomness of the P2Is and security capability by reducing control signals and other data encapsulation using the protection monitor 85, wherein the P2I codes 83 are to proactively protect information in computing systems built with the P2 processing system 100 and the computing systems themselves and the SCI codes 84 are to produce compatible execution results of the executable programs comprising a single or plurality of UIs, format, fragment, and allocate the P2Is and the SCIs, which are compiled from an unprotected machine language code compiled by unprotected compilers with a target instruction set.

The P2I set transformation compilation 80 also identifies a single or plurality of instructions in the unprotected machine language code to evaluate possible fragment of the P2I using a P2 compilation 81, generates either a plurality of the P2Is and addresses to allocate the P2Is in the P2I memory 88 and a plurality of the SCIs and addresses to allocate the SCIs in the SCI memory 89 or a P2I and an address to evaluate possible fragment of the SCIs, generates a plurality of fragmented SCIs and addresses to allocate the fragmented SCIs or iterates the P2 compilation 81 until the P2 compilation 81 is completed, and then allocates the P2Is and the SCIs generated to the P2I memory 88 and to the SCI memory 89.

The P2 processing system 100 generates authorized executable codes and provides to authorized P2Is to a single or plurality of the unprotected processors 98 via the P2 hardware 91 so that the unprotected processors 98 produce compatible results of the authorized executable codes, and allocates the P2Is and the SCIs to the P2I cache and memory 88 and the SCI cache and memory 89 for parallel fetching to a plurality of the unprotected processors 98 using the allocation process of the P2Is and the SCIs.

In one embodiment, the P2processing unit hardware 90 comprises a single or plurality of unprotected processors, a P2 hardware, and a P2 data memory system.

The P2 processing unit hardware 90 permits only authorized persons or computing systems to use protected information that is generated and modified by the P2 processing unit hardware, dynamically generates a plurality of unique P2I sets 82, and randomly switches one of the unique P2I sets 82 at random or scheduled time to detect and delete a single or plurality of unauthorized executable programs and accesses secured information, authenticates each of the executable programs and information according to the authorized P2I set 82, swiftly resumes scheduled tasks, including detecting, disabling, and deleting an unauthorized code upon admitting into the P2 processing unit 90 and executing only an authorized code comprising of the P2I code 83 and the SCI code 84 and P2 information and producing equal or compatible outcomes, detects, disables and/or deletes unauthorized P2Is and/or SCIs, delivers only authorized P2Is and/or SCIs to the unprotected processors 98, fetches and decodes a single or plurality of P2Is and/or SCIs from the P2I memory system 87, identifies and removes a single or plurality of unauthorized P2Is and/or SCIs, and schedules and fetches a single or plurality of authorized P2Is and/or SCIs to the unprotected processors.

In one embodiment, a single or plurality of the unprotected processors comprises an unprotected processor 98, a plurality of homogeneous unprotected processors, and a plurality of heterogeneous unprotected processors.

In one embodiment, the P2I memory system 87 provides locations of the P2I code 83 in the P2I cache and memory 88 and he SCI code 84 in the SCI cache and memory 89 and P2 data in a P2 data memory 95 and non-P2 data in a non-P2 data memory system 96 in a P2 data memory system 97 to the unprotected processors 98 in the P2 processing system 100, executes P2Is and SCIs delivered from the P2 instruction (P2I) scheduler 92 via the P2 instruction (P2I) decoder 93 and the P2 instruction (P2I) fetcher 94, wherein the P2Is and the SCIs are allocated into the separately or concurrently accessible P2 instruction (P2I) memory system the P2I memory system 87 comprising of the P2I cache and memory 88 and the SCI cache and memory 89 in the P2 processing system 100, receives the P2Is and/or the SCIs from the P2I scheduler 92, more specifically, receives the SCIs scheduled, including the P2 flow-control instructions (e.g., conditional branches) from the P2I scheduler 92 if the flow-control instructions are predicted, fetches shuffled P2Is 64 and SCIs in parallel with transformed P2 instruction (P2I) memory system if necessary, wherein the transformed P2I memory system 87 is to provide the P2Is and the SCIs to a plurality of the unprotected processors 98 used in the P2 processing unit hardware 90, receives authorized P2Is and/or authorized SCIs stored in the P2I cache and memory 88 and the SCI cache and memory 89 in the P2I memory system 87, receives the authorized P2Is and/or the authorized SCIs for processing the authorized P2Is and/or the authorized SCIs after the P2 processing system 100, excluding the unprotected processors 98, detects, disables and/or deletes unauthorized P2Is and/or unauthorized SCIs, accesses and processes scheduled authorized P2Is and/or authorized SCIs alongside P2 data stored in the P2 data memory system 97, produces compatible results of authorized executable codes generated by the P2I set transformation compilation 80, and stores and utilizes the P2 data and/or the non-P2 data processed, fetches and decodes a single or plurality of the P2Is and/or the SCIs from the P2I memory system 87, identifies and removes a single or plurality of unauthorized P2Is and/or unauthorized SCIs, and schedules and fetches a single or plurality of authorized P2Is and/or authorized SCIs, fetches a single or plurality of the authorized SCIs from the P2I scheduler 92 for scheduling a single or plurality of the authorized SCIs decoded by the P2I decoder 93 after removing a single or plurality of unauthorized P2Is detected by the P2I decoder 93 from the P2I cache and memory 88 and/or the associated a single or plurality of the SCIs from the SCI cache and memory 89 if needed and updating decoding information generated of P2Is from a P2I set 82 whenever the P2I set 82 is switched to a different P2I set 82, and receives the P2Is and the SCIs in parallel from the P2 cache and memory 88 and the SCI cache and memory 89 where the P2Is and the SCIs are allocated according to the allocation of the P2Is and the SCIs.

In one embodiment, the P2 hardware 91 comprises a P2 instruction (P2I) fetcher 94, a P2 instruction (P2I) decoder 93, and a P2 instruction (P2I) scheduler 92.

The P2 hardware 91 fetches both of authorized P2Is and unauthorized P2Is from the P2I cache and memory 88 to the P2I fetcher 94 until a single or plurality of branch prediction results are forwarded to the P2I fetcher 94, fetches both of authorized SCIs and unauthorized SCIs in order with the P2I fetcher 94 upon receiving addresses of the authorized SCIs and the unauthorized SCIs from the P2I decoder 93, fetches certain types of the P2Is along with the SCIs for code compatibility via the P2I fetcher 94, wherein the certain types of the P2Is are compiled according to different segmentation modes, wherein the different segmentation modes include (1) a desired level of security, (2) a desired level of performance, and (3) mixed features of security and performance as an optimization mode, fetches the P2Is from the P2I cache and memory 88 to the P2I fetcher 94 and/or fetches the SCIs from the SCI cache and memory 89 to the P2I fetcher 94 in serial or parallel, fetches shuffled P2Is 64 and SCIs in parallel to a plurality of the unprotected processors 98, decodes shuffled P2Is according to the decoding information generated from the P2I set 82, forwards addresses of the authorized SCIs to the P2I fetcher 94 for fetching the authorized SCIs in order, decodes the shuffled P2Is fetched from the P2I fetcher 94 and the P2I cache and memory 88 according to decoding information generated from the P2I set 82 with the P2I decoder 93, transmits authorized and shuffled P2Is to the P2I scheduler 92 if decode results of the shuffled P2Is indicate that the shuffled P2Is are the authorized shuffled P2Is, otherwise discards the shuffled P2Is from the P2I decoder 93 and transmits the decode results of the unauthorized and shuffled P2Is to the P2I cache and memory 88, holds the decode results of the authorized and shuffled P2Is in the P2I decoder 93 until the P2I scheduler 92 receives the decode results of the authorized and shuffled P2Is, detects unauthorized and shuffled P2Is generated by an unauthorized P2 processing system, disables the unauthorized and shuffled P2Is stored in the P2I cache and memory 88, deletes every unauthorized, shuffled P2I from the P2 hardware 91, wherein the shuffled P2Is are the P2Is compiled from a single or plurality of unprotected instructions (UIs) by the P2 compilation 81 according to the P2 instruction format followed by shuffling the P2Is by the P2 instruction formatter 6, removes a single or plurality of unauthorized P2Is detected from the P2I cache and memory 88 and/or the associated a single or plurality of SCIs from the SCI cache and memory 89 by the P2I decoder 93 if needed, updates decoding information generated of P2Is from the P2I set 82 by the P2I decoder 93 whenever a P2I set 82 is switched to a different P2I set, schedules a single or plurality of authorized SCIs received from the P2I decoder with the P2I scheduler 92, forwards necessary P2Is, including P2 flow-control instructions (e.g., conditional branches) or P2Is that need to be fetched from the P2I scheduler 92 to the unprotected processors 98, and provides authorized P2Is from the P2I scheduler 92 to the unprotected processors 98 that produces compatible results of authorized executable codes generated by the P2I set transformation compilation.

In one embodiment, the P2 data memory system 97 comprises a P2 data memory 95 and a non-P2 data memory 96.

The P2 data memory system 97 provides P2 data or non-P2 data to a protection monitor 85 for handling protection monitoring and memory management operations, including configuration of a single or plurality of P2 memory zones in the P2 data memory system 97 in terms of (1) different sizes of the P2 data memory zones and non-P2 data memory zones in an unified memory or separated memories, i.e., the P2 data memory 95 and the non-P2 data memory 96 in the P2 data memory system 97, (2) protection priorities according to worth of the P2 data, usage of the P2 data, and other means, (3) types of protection, including randomness, selection and generation of passcode and encryption, and other means are not limited in its application to the details of construction or to the arrangements of the components set forth in the description, holds and shares the P2 data for identifying protecting resource mappings and management 86 operations, receives P2 monitoring information from the protection monitor 85 to synchronize the protection and memory management operations configured with the protection monitor 85, transmits to and receives from the unprotected processors 98 for producing compatible results of authorized executable codes, storing and utilizing the P2 data, and other means needed for between the unprotected processors and the data memory systems, holds both the P2 data and the non-P2 data, wherein the non-P2 data are generated by, received from, or converted from the P2 data to the non-P2 data with a single or plurality of unauthorized P2 processing systems or unauthorized non-P2 processing systems, wherein the non-P2 processing systems are computing systems, which do not prevent machine language code of unauthorized program from being executed by the unprotected processors 98, receives the P2 data from the unprotected processors 98 and transmits the P2 data to other unprotected processors 98 in the same authorized or unauthorized P2 processing system or in the different authorized or unauthorized P2 processing system, stores and exchanges the P2 or the non-P2 data, including encrypted P2 data, generated by the unprotected processors 98 with the authorized P2Is and/or SCIs, stores the P2 data and the non-P2 data generated and accessed during operations of the P2 processing system 100, and stores the P2 data that are accessed and processed the scheduled authorized P2Is and/or SCIs by the unprotected processors 98.

In one embodiment, the P2 instruction (P2I) memory system 87 comprises a P2 instruction (P2I) formatter 6, a P2 instruction (P2I) cache and memory 88, and a SC instruction (SCI) cache and memory 89.

The P2I memory system 87 stores shuffled P2Is 64 and SCIs and delivers authorized P2Is and/or authorized SCIs to the unprotected processors 98, stores each fragmented P2I and associated fragmented SCIs generated by the P2 compilation 81 with the P2I set 82 if a plurality of the fragmented SCIs is fetched concurrently, provides a single or plurality of the shuffled P2Is and/or SCIs to a single or plurality of the unprotected processors 98 in the P2 processing unit hardware 90 for fetching, decoding, and scheduling a single or plurality of the shuffled P2Is and/or the associated SCIs, provides the shuffled P2Is and/or the SCIs in serial or parallel to the P2I fetcher 94 in the P2 hardware 91 for processing with a single or plurality of unprotected processors 98, allocates the fragmented P2I and the associated fragmented SCIs to different locations for parallel accessing, provides additional P2I and SCI fragmentation for the enhanced probability of randomness to achieve higher levels of cybersecurity, allocates the shuffled P2Is and/or the SCIs for separate or concurrent access from and to the P2I memory system 87 comprising of the P2I cache and memory 88 and the SCI cache and memory 89, fetches the shuffled P2Is and SCIs in parallel with P2I memory system 87 if necessary, wherein the P2I memory system 87 is to provide the shuffled P2Is and the SCIs to a plurality of the unprotected processors 98 used in the P2 processing unit hardware 90, provides a plurality of locations of P2I codes in the P2I cache and memory 88 and a plurality of locations of SCI codes in the SCI cache and memory 89 in the P2I memory system 87 to the unprotected processors 98 in the P2 processing system 100, wherein the P2I codes are for proactively protecting information in computing systems built with the P2 processing system 100 and the computing systems themselves, wherein the SCI codes are for producing compatible execution results of executable programs, wherein the executable programs comprise a single or plurality of UIs, allocates the shuffled P2Is according to locations generated by a code allocation method if a plurality of the unprotected processors 98 needs to fetch the shuffled P2Is in parallel, allocates the SCIs according to locations generated by the code allocation method if a plurality of the unprotected processors 98 needs to fetch the SCIs in parallel, generates the shuffled P2I of the P2I by shuffling an identification field and a single or plurality of other fields in the P2I in a random or predefined manner with the P2I formatter 6, wherein the P2I formatter 6 generates a shuffled unique identification field with a bit shuffling logic according to random bit-shuffling transformation data and bit shuffling metadata, wherein the random bit-shuffling transformation data is a single or plurality of indexes selected in a random or predefined manner for shuffling a single or plurality of bits in a single or plurality of fields of the P2I, wherein the bit shuffling metadata provides description and information about a single or plurality of indexes for shuffling order of bits and/or of P2I fields, and other information and description of the bits and the P2I fields that are shuffled, generates random bit orders of the P2Is in the P2I formatter 6 on the fly with (1) random bit-shuffling transformation data 62 to configure the bit shuffling logic 61 and produces associated bit and/or field shuffling metadata 63, including (1) segmentation mode, (2) orders of bits, (3) authentication information, (4) expiration time, etc., wherein the bit and/or field shuffling metadata 63 is used for generating a different format of the P2I, shuffles bits of each P2I to recover bit-orders of the P2I using the transformation information for dynamic retransformation of the P2I formatter 6, and generates a shuffled P2I 64 of a P2I by shuffling bits of the P2I in a random or predetermined manner by interfacing a hardware component containing random bit-shuffling transformation data 62 to the P2I formatter 6 including the bit shuffling logic 61 for configuring the bit shuffling logic 61, translating a P2I format to another format within a single of plurality of instruction cycles, and producing associated bit and/or field shuffling meta data 63 and another hardware component containing bit and/or field shuffling meta data 63.

In one embodiment, the P2 instruction (P2I) set transformation compilation 80 comprises a P2 compilation 81, a P2 instruction (P2I) set 82, a P2 instruction (P2I) code 83, a segmented compatible (SC) instruction code 84, a protecting resource mappings and management86, and a protection monitor 85.

The P2I set transformation compilation 80 dynamically recompiles a current authorized code to generate a P2I code 83 and a SCI code 84, identifies random instruction segments in a SCI code as per the selected segmentation mode, which represents a desired level of security, a desired level of performance, and mixed features of security and performance, transforms identified segments to the SCI code 84 by reformatting segments as per the identified P2I set 82, generates decoding information to decode shuffled P2Is according to the P2I set 82, compiles an executable program to produce the P2I code 83 and the SCI code 84, wherein the P2I code and the SCI code are for proactively protecting information in computing systems and the computing systems themselves and for producing compatible execution results of the executable program, wherein an executable program comprises a single or plurality of unprotected instructions (UIs), produces a single or plurality of P2I sets from an UI set used in the unprotected systems and the executable program, wherein the P2I set comprises a plurality of P2Is transformed from the UIs used in the executable program, determines (1) how many a single UI or a plurality of consecutive UIs is assigned to a P2I for enhancing code security by increasing probability of the possible combinations of different P2Is generated from the single UI or the plurality of consecutive UIs, and (2) how many SCIs are generated from the executable program for controlling different levels of code protections and performance and resources, including instruction memory size, according to characteristics of the executable program and the different types of computing systems,

In one embodiment, the P2 compilation 81 creates a single or plurality of SCIs from every UI stream in an unprotected executable code with a series of the consecutive P2 compilation when an authorized identification is accepted, continues operations of the P2 compilation until last segment of the unprotected executable code is compiled, compiles an unprotected code, such as application and system software written in an instruction set, with the P2 compilation at random time intervals, generates a single or plurality of P2I sets for P2I code compilation, identifies a single or plurality of UIs in an unprotected machine language code to evaluate possible fragment of the P2I, generates either a plurality of the P2Is and addresses of the P2Is to allocate the P2Is into the P2I memory and a plurality of the SCIs and addresses to allocate the SCIs in the SCI memory or a P2I and addresses of the SCIs, evaluates possible fragment of the SCIs and fragment either a plurality of the SCIs, generates a plurality of the fragmented SCIs and the addresses to allocate the fragmented SCIs or iterate the P2 compilation until the P2 compilation is completed, allocates the P2Is and the SCIs generated to the P2I memory and to the SCI memory, respectively, and compiles a plurality of the P2Is to generate distinguished P2 compilation results from the results of other computing systems for the code security.

In one embodiment, the P2I set 82 relocates a single or plurality of bits in a single or plurality of different fields in the P2I set to the same or different locations in the P2I set 82 to generate a plurality of different formats of the P2I sets, comprises a plurality of P2Is transformed from the UIs used in the executable program, provides compatible execution results regardless of which P2I set is used for the P2 compilation 81 of the same executable program, provides a plurality of unique P2I sets 82 dynamically generated and one of the P2I sets randomly switched at random or scheduled time to detect and delete a single or plurality of unauthorized executable programs and accesses secured information, provides a mean to authenticate each of the executable programs and information according to the authorized P2I set, reformats segments as per the identified P2I set for transforming the identified segments to the SCI code, provides decoding information to the P2I decoder to decode the shuffled P2Is fetched from the P2I fetcher and the P2I cache and memory, provides an encryption identification to create a protected data file for decrypting the data file when reading data from the file after being protected, provides a single or plurality of P2I sets for P2I code compilation, updates decoding information generated of P2Is from the P2I set, switches a P2I set to a different P2I set, and generates a single or plurality of P2I sets for P2I code compilation.

In one embodiment, the P2I code 83 proactively protects information in computing systems built with the P2 processing system 100 and the computing systems themselves, is generated by compiling UIs in an executable program via the P2 compilation 81, wherein an executable program comprises a single or plurality of the UIs, is dynamically recompiled from a current authorized code via the P2I set transformation compilation 80, is produced by the P2 compilation 81 for compiling a single or plurality of executable programs, provides only an authorized code to execute for swiftly resuming scheduled tasks, including detecting, disabling, and deleting an unauthorized code upon admitting into the P2 processing unit hardware 90, is used for increasing randomness of P2Is and security capability by reducing control signals and other data encapsulation, and is forwarded to the P2I formatter 6 for generating random bit-order of P2Is, as shuffled P2Is of the P2Is by shuffling an identification field and a single or plurality of other fields in the P2Is in a random or predefined manner, wherein a shuffled unique identification field is generated by a bit shuffling logic 61 according to random bit-shuffling transformation data 62 and bit and/or field shuffling metadata 63.

In one embodiment, the SCI code 84 proactively protects information in computing systems built with the P2 processing system 100 and the computing systems themselves with the associated P2I code 83, is generated by compiling the UIs in the executable program with the associated P2I code 83 via the P2 compilation 81, wherein the executable program comprises a single or plurality of the UIs, produces compatible execution results of the executable program with the associated P2I code 83, produces compatible results of the UIs while securing code by distinguishing the UI code compiled for common usage from the SCI code compiled for authorized usage with only a single or plurality of authorized computing systems, produces a single or plurality of the P2I codes 83 and a single or plurality of the SCI codes 84 by compiling a single or plurality of executable programs, is dynamically recompiled from a current authorized code via the P2I set transformation compilation 80 with the associated P2I code 83, is produced by the P2 compilation 81 for compiling a single or plurality of executable programs with the associated P2I code 83, provides only an authorized code to execute for swiftly resuming scheduled tasks after detecting, disabling, and deleting an unauthorized code upon admitting into the P2 processing unit hardware 90, identifies random instruction segments in the SCI code 84 as per the selected segmentation mode, which represents a desired level of security, a desired level of performance, and mixed features of security and performance via the P2I set transformation compilation 80, transforms the identified segments to the SCI code 84 by reformatting segments as per the identified P2I set via the P2I set transformation compilation 80, creates a single or plurality of the SCIs from every UI stream in an unprotected executable code via a series of the consecutive P2 compilation 81 when an authorized identification is accepted, wherein the P2 compilation 81 continues until the last segment of the unprotected executable code is compiled, and provides inputs to the P2I codes 83 and the SCI codes 84 for increasing randomness of P2Is and security capability by reducing control signals and other data encapsulation with the associated P2I code.

In one embodiment, the protecting resource mappings and management 86 transmits P2 monitoring information from the protection monitor 85 to synchronize the protection and memory management operations configured with the protection monitor 85, receives P2 monitoring information from the protection monitor 85 to synchronize the protection and memory management operations configured with the protection monitor 85, configures a single or plurality of computing systems for evaluating the executable programs and information management, and configures and identifies the management and monitoring policies and protocols between the same and different types of computing systems.

In one embodiment, the protection monitor 85 handles the operations related to the protecting resource mappings and management 86 alongside the P2 compilation 81 and the P2 data memory system 97, provides inputs to the P2I codes 83 and the SCI codes 84 for increasing randomness of the P2Is and security capability by reducing control signals and other data encapsulation, receives P2 data or non-P2 data from the P2 data memory system 97 for handling protection monitoring and memory management operations, including configuration of a single or plurality of P2 memory zones in the P2 data memory system 97 in terms of (1) different sizes of the P2 data memory zones and non-P2 data memory zones in an unified memory or separated memories, i.e., the P2 data memory 95 and the non-P2 data memory 96 in the P2 data memory system 97, (2) protection priorities according to worth of the P2 data, usage of the P2 data, and other means, (3) types of protection, including randomness, selection and generation of passcode and encryption, and other means are not limited in its application to the details of construction or to the arrangements of the components in the description, holds and shares the P2 data in the P2 data memory system 97 for identifying protecting resource mappings and management operations, provides P2 monitoring information to synchronize the protection and memory management operations configured with the protection monitor 85, and transmits to and receives from the unprotected processors 98 for producing compatible results of authorized executable codes, storing and utilizing the P2 data, and other means needed for between the unprotected processors 98 and the P2 data memory system 97.

The presented P2 processing system 100 is not limited in its application to the details of construction or to the arrangements of the components set forth in the above description or illustrated in FIG. 2.

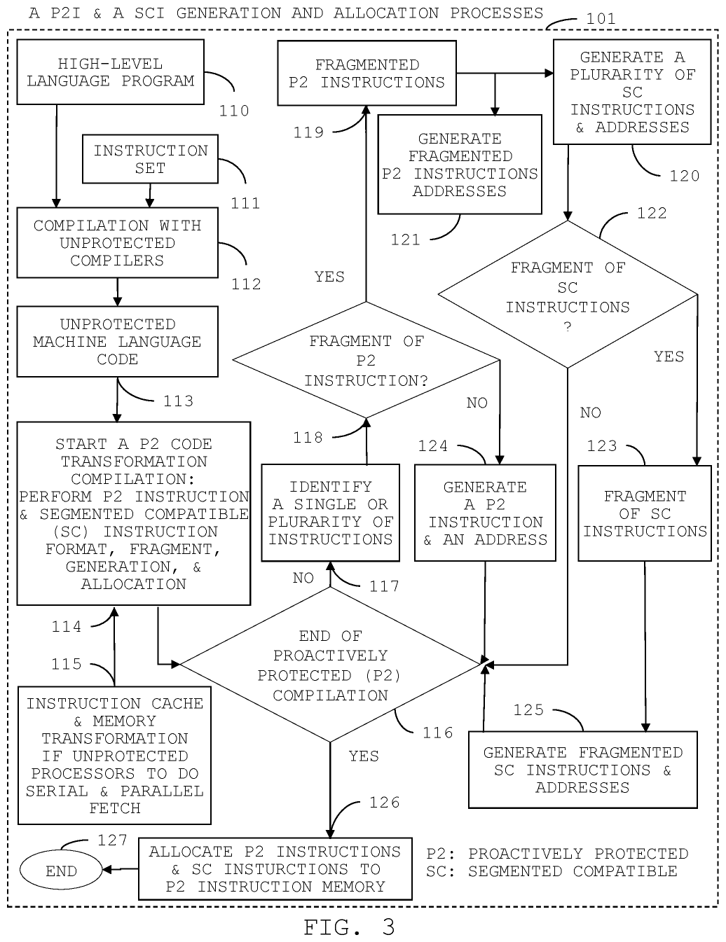

FIG. 3 is a diagram showing one embodiment of a P2I and a SCI generation and allocation processes 101 that operate to: format, fragment, generate, and allocate P2Is and SCIs via a P2 code transformation compilation 114, identify a single or plurality of instructions 117 in the unprotected machine language code 113 according to the format of the instructions, fragment the instructions identified to generate a single or plurality of fragmented P2Is 119 and addresses of the fragmented P2Is 121 and an associated single or plurality of the fragmented SCIs 123 and addresses of the fragmented SCIs 125 if needed, otherwise, generate a single or plurality of P2Is and addresses of the P2Is 124 and an associated single or plurality of the SCIs and addresses of the SCIs 120, allocate the P2Is to the P2I cache & memory and the SCIs to the SCI cache & memory for serial and/or parallel fetching 115 to a single or plurality of the unprotected processors 98 with the P2I and the SCI allocation process 101, allocate the P2Is to the P2I memory and the SCIs to the SCI memory 126 according to addresses generated until the P2 compilation is completed, and do not limited in its application to the details of construction or to the arrangements of the components set forth in the above description or illustrated in FIG. 3.

What is claimed is:

1. A proactively protected (P2) processing system for cybersecurity, the P2 processing system comprising:
a P2 processing unit hardware;
a P2 instruction (P2I) memory system as hardware; and
a P2 instruction (P2I) set transformation compilation as software,
wherein the P2 processing system is operable to:
perform proactive protections of the P2 processing systems;
prevent unauthorized persons from malicious usages of the P2 processing systems;
provide proactive protection of a single or plurality of unprotected processors in a physical layer for cybersecurity;
permit only authorized persons or computing systems to use protected information that is generated and modified by the P2 processing unit hardware;
detect, disable, and/or delete unauthorized P2 instructions (P2Is) and/or SC instructions (SCIs);
deliver only authorized P2Is and/or SCIs to the unprotected processors;
transform a plurality types of the unprotected processors, including central processing units (CPUs), mobile application processors (APs), digital signal processors (DSPs), graphic processing units (GPUs), microcontroller units (MCUs), and other embedded or application specific processors being used in reactively protected or unprotected computing systems, to a plurality types of proactively protected processing unit hardware;
dynamically generate a plurality of unique P2I sets, randomly switches one of a plurality of the P2I sets at random or scheduled time to detect and delete unauthorized executable program;
access secured information and authenticate executable program and information according to authorized P2I set by a single or plurality of P2 processing units hardware;
generate authorized executable codes;
provide to authorized P2Is to a single or plurality of the unprotected processors via the P2 hardware so that the unprotected processors produce compatible results of the authorized executable codes;
allocate the P2Is and the SCIs to the P2I cache and memory and the SCI cache and memory for parallel fetching to a plurality of the unprotected processors using the allocation process of the P2Is and the SCIs,
wherein the P2I set transformation compilation in the P2 processing system is operable to:
dynamically recompile a current authorized code to generate a P2 instruction (P2I) code and a segmented compatible instruction (SCI) code;
identify random instruction segments in the SCI code as per the selected segmentation mode, which represents a desired level of security or performance;
transform the identified segments to the SCI code by reformatting segments as per the identified P2I set;
generate configuration information of P2Is in the P2I set to decode the P2Is, creates a single or plurality of the SCIs from every unprotected instruction stream in an unprotected executable code when an authorized identification is accepted;
continue a series of consecutive P2 compilation until the last segment of the unprotected executable code is compiled;
use transformation information for dynamic retransformation of a P2 instruction (P2I) formatter to shuffle bits of each P2I to recover bit-orders of the P2I;
compile executable programs compiled for an unprotected system and/or an application program with an unprotected instruction (UI) set;
produce the P2I codes and the SCI codes;
generate a single or plurality of the P2I sets for P2 compilation;
handle operations related to a protecting resource mappings and management alongside the P2 compilation and a P2 data memory system using a protection monitor;
provide inputs to the P2I codes and the SCI codes for increasing randomness of the P2Is and security capability by reducing control signals and other data encapsulation using the protection monitor,
wherein the P2I codes are to proactively protect information in computing systems built with the P2 processing system and the computing systems themselves and the SCI codes are to produce compatible execution results of the executable programs comprising a single or plurality of UIs, format, fragment, and allocate the P2Is and the SCIs, which are compiled from an unprotected machine language code compiled by unprotected compilers with a target instruction set;
identify a single or plurality of instructions in the unprotected machine language code to evaluate possible fragment of the P2I using a P2 compilation;
generate either a plurality of the P2Is and addresses to allocate the P2Is in the P2I memory and a plurality of the SCIs and addresses to allocate the SCIs in the SCI memory or a P2I and an address to evaluate possible fragment of the SCIs;
generate a plurality of fragmented SCIs and addresses to allocate the fragmented SCIs or iterates the P2 compilation until the P2 compilation is completed; and
allocate the P2Is and the SCIs generated to the P2I memory and to the SCI memory.

2. The P2 processing system of claim 1, wherein the P2 processing unit hardware comprising:
a single or plurality of unprotected processors;
a P2 hardware; and
a P2 data memory system,
wherein the P2 processing unit hardware is operable to:
permit only authorized persons or computing systems to use protected information that is generated and modified by the P2 processing unit hardware;
dynamically generate a plurality of unique P2I sets;
randomly switch one of the unique P2I sets at random or scheduled time to detect and delete a single or plurality of unauthorized executable programs and access secured information;
authenticate each of the executable programs and information according to the authorized P2I set;
swiftly resume scheduled tasks, including detecting, disabling, and deleting an unauthorized code upon admitting into the P2 processing unit and executing only an authorized code comprising of the P2I code and the SCI code and P2 information and producing equal or compatible outcomes;
detect, disable and/or delete unauthorized P2Is and/or SCIs;
deliver only authorized P2Is and/or SCIs to the unprotected processors;
fetch and decode a single or plurality of P2Is and/or SCIs from the P2I memory system;
identify and remove a single or plurality of unauthorized P2Is and/or SCIs; and
schedule and fetch a single or plurality of authorized P2Is and/or SCIs to the unprotected processors.

3. The P2 processing unit hardware of claim 2, wherein a single or plurality of the unprotected processors comprising:
an unprotected processor;
a plurality of homogeneous unprotected processors; and
a plurality of heterogeneous unprotected processors,
wherein a single or plurality of the unprotected processors 98 including central processing units (CPUs), mobile application processors (APs), digital signal processors (DSPs), graphic processing units (GPUs), microcontroller units (MCUs), and other embedded or application specific processors being used in reactively protected or unprotected computing systems found in prior arts;
perform proactive protection with the P2 processing unit hardware 90 in a physical layer for cybersecurity;
provide locations of the P2I code 83 in the P2I cache and memory 88 and the SCI code 84 in the SCI cache and memory 89 and P2 data in a P2 data memory 95 and non-P2 data in a non-P2 data memory system 96 in a P2 data memory system 97 to the unprotected processors 98 in the P2 processing system 100;
execute P2Is and SCIs delivered from the P2 instruction (P2I) scheduler 92 via the P2 instruction (P2I) decoder 93 and the P2 instruction (P2I) fetcher 94,
wherein the P2Is and the SCIs are allocated into the separately or concurrently accessible P2 instruction (P2I) memory system 87 comprising of the P2I cache and memory 88 and the SCI cache and memory 89 in the P2 processing system 100;
receive the P2Is and/or the SCIs from the P2I scheduler 92;
more specifically, receive the SCIs scheduled, including the P2 flow-control instructions (e.g., conditional branches) from the P2I scheduler 92 if the flow-control instructions are predicted;
fetch shuffled P2Is and SCIs in parallel with transformed P2 instruction (P2I) memory system if necessary,
wherein the transformed P2I memory system 87 is to provide the P2Is and the SCIs to a plurality of the unprotected processors 98 used in the P2 processing unit hardware 90;
receive authorized P2Is and/or authorized SCIs stored in the P2I cache and memory 88 and the SCI cache and memory 89 in the P2I memory system 87;
receive the authorized P2Is and/or the authorized SCIs for processing the authorized P2Is and/or the authorized SCIs after the P2 processing system 100, excluding the unprotected processors 98;
detect, disable and/or delete unauthorized P2Is and/or unauthorized SCIs;
access and process the scheduled authorized P2Is and/or the authorized SCIs alongside P2 data stored in the P2 data memory system 97;
produce compatible results of authorized executable codes generated by the P2I set transformation compilation 80;
store and utilize the P2 data and/or the non-P2 data processed;
fetch and decode a single or plurality of the P2Is and/or the SCIs from the P2I memory system 87;
identify and remove a single or plurality of the unauthorized P2Is and/or the unauthorized SCIs; and
schedule and fetch a single or plurality of the authorized P2Is and/or the authorized SCIs;
fetch a single or plurality of the authorized SCIs from the P2I scheduler 92 for scheduling a single or plurality of the authorized SCIs decoded by the P2I decoder 93 after removing a single or plurality of the unauthorized P2Is detected by the P2I decoder 93 from the P2I cache and memory 88 and/or the associated a single or plurality of the SCIs from the SCI cache and memory 89 if needed and updating decoding information generated of P2Is from a P2I set 82 whenever the P2I set 82 is switched to a different P2I set 82; and
receive the P2Is and the SCIs in parallel from the P2 cache and memory 88 and the SCI cache and memory 89 where the P2Is and the SCIs are allocated according to the allocation of the P2Is and the SCIs.

4. The P2 processing unit hardware of claim 2, wherein the P2 hardware comprising:
a P2 instruction (P2I) fetcher;
a P2 instruction (P2I) decoder; and
a P2 instruction (P2I) scheduler,
wherein the P2 hardware is operable to:
fetch both of authorized P2Is and unauthorized P2Is from the P2I cache and memory to the P2I fetcher until a single or plurality of branch prediction results are forwarded to the P2I fetcher;
fetch both of authorized SCIs and unauthorized SCIs in order with the P2I fetcher upon receiving addresses of the authorized SCIs and the unauthorized SCIs from the P2I decoder;
fetch certain types of the P2Is along with the SCIs for code compatibility via the P2I fetcher,
wherein the certain types of the P2Is are compiled according to different segmentation modes,
wherein the different segmentation modes include (1) a desired level of security, (2) a desired level of performance, and (3) mixed features of security and performance as an optimization mode;
fetch the P2Is from the P2I cache and memory to the P2I fetcher and/or fetches the SCIs from the SCI cache and memory to the P2I fetcher in serial or parallel;
fetch shuffled P2Is and SCIs in parallel to a plurality of the unprotected processors;
decode shuffled P2Is according to the decoding information generated from the P2I set;
forward addresses of the authorized SCIs to the P2I fetcher for fetching the authorized SCIs in order;
decode the shuffled P2Is fetched from the P2I fetcher and the P2I cache and memory according to decoding information generated from the P2I set with the P2I decoder;
transmit authorized and shuffled P2Is to the P2I scheduler if decode results of the shuffled P2Is indicate that the shuffled P2Is are the authorized shuffled P2Is, otherwise discard the shuffled P2Is from the P2I decoder;
transmit the decode results of the unauthorized and shuffled P2Is to the P2I cache and memory;
hold the decode results of the authorized and shuffled P2Is in the P2I decoder until the P2I scheduler receives the decode results of the authorized and shuffled P2Is;
detect unauthorized and shuffled P2Is generated by an unauthorized P2 processing system;
disable the unauthorized and shuffled P2Is stored in the P2I cache and memory;
delete every unauthorized, shuffled P2I from the P2 hardware,
wherein the shuffled P2Is are the P2Is compiled from a single or plurality of unprotected instructions (UIs) by the P2 compilation according to the P2 instruction format followed by shuffling the P2Is by the P2 instruction formatter;
remove a single or plurality of unauthorized P2Is detected from the P2I cache and memory and/or the associated a single or plurality of SCIs from the SCI cache and memory by the P2I decoder if needed;
update decoding information generated of P2Is from the P2I set by the P2I decoder whenever a P2I set is switched to a different P2I set;
schedule a single or plurality of authorized SCIs received from the P2I decoder with the P2I scheduler;
forward necessary P2Is, including P2 flow-control instructions (e.g., conditional branches) or P2Is that need to be fetched from the P2I scheduler to the unprotected processors; and
provide authorized P2Is from the P2I scheduler to the1 unprotected processors that produces compatible results of authorized executable codes generated by the P2I set transformation compilation.

5. The P2 processing unit hardware of claim 2, wherein the P2 data memory system comprising:
a P2 data memory; and
a non-P2 data memory,
wherein the P2 data memory system is operable to:
provide P2 data or non-P2 data to a protection monitor for handling protection monitoring and memory management operations, including configuration of a single or plurality of P2 memory zones in the P2 data memory system in terms of (1) different sizes of the P2 data memory zones and non-P2 data memory zones in an unified memory or separated memories, i.e., the P2 data memory and the non-P2 data memory 96 in the P2 data memory system, (2) protection priorities according to worth of the P2 data, usage of the P2 data, and other means, (3) types of protection, including randomness, selection and generation of passcode and encryption, and other means are not limited in its application to the details of construction or to the arrangements of the components set forth in the description;
hold and share the P2 data for identifying protecting resource mappings and management operations;
receive P2 monitoring information from the protection monitor to synchronize the protection and memory management operations configured with the protection monitor;
transmit to and receive from the unprotected processors for producing compatible results of authorized executable codes, storing and utilizing the P2 data, and other means needed for between the unprotected processors and the data memory systems;
hold both the P2 data and the non-P2 data,
wherein the non-P2 data are generated by, received from, or converted from the P2 data to the non-P2 data with a single or plurality of unauthorized P2 processing systems or unauthorized non-P2 processing systems, wherein the non-P2 processing systems are computing systems, which do not prevent machine language code of unauthorized program from being executed by the unprotected processors;
receive the P2 data from the unprotected processors and transmit the P2 data to other unprotected processors in the same authorized or unauthorized P2 processing system or in the different authorized or unauthorized P2 processing system;
store and exchange the P2 or the non-P2 data, including encrypted P2 data, generated by the unprotected processors with the authorized P2Is and/or SCIs;
store the P2 data and the non-P2 data generated and accessed during operations of the P2 processing system; and
store the P2 data that are accessed and processed the scheduled authorized P2Is and/or SCIs by the unprotected processors.

6. The P2 processing system of claim 1, wherein the P2 instruction (P2I) memory system comprising:
a P2 instruction (P2I) formatter;
a P2 instruction (P2I) cache and memory; and
a SC instruction (SCI) cache and memory,
wherein the P2I memory system is operable to:
store shuffled P2Is and SCIs and delivers authorized P2Is and/or authorized SCIs to the unprotected processors;
store each fragmented P2I and associated fragmented SCIs generated by the P2 compilation with the P2I set if a plurality of the fragmented SCIs is fetched concurrently;
provide a single or plurality of the shuffled P2Is and/or SCIs to a single or plurality of the unprotected processors in the P2 processing unit hardware for fetching, decoding, and scheduling a single or plurality of the shuffled P2Is and/or the associated SCIs;
provide the shuffled P2Is and/or the SCIs in serial or parallel to the P2I fetcher in the P2 hardware for processing with a single or plurality of unprotected processors;
allocate the fragmented P2I and the associated fragmented SCIs to different locations for parallel accessing;
provide additional P2I and SCI fragmentation for the enhanced probability of randomness to achieve higher levels of cybersecurity;
allocate the shuffled P2Is and/or the SCIs for separate or concurrent access from and to the P2I memory system comprising of the P2I cache and memory and the SCI cache and memory;
fetch the shuffled P2Is and SCIs in parallel with P2I memory system if necessary,
wherein the P2I memory system is to provide the shuffled P2Is and the SCIs to a plurality of the unprotected processors used in the P2 processing unit hardware;
provide a plurality of locations of P2I codes in the P2I cache and memory and a plurality of locations of SCI codes in the SCI cache and memory in the P2I memory system to the unprotected processors in the P2 processing system,
wherein the P2I codes are for proactively protecting information in computing systems built with the P2 processing system and the computing systems themselves,
wherein the SCI codes are for producing compatible execution results of executable programs,
wherein the executable programs comprise a single or plurality of UIs;
allocate the shuffled P2Is according to locations generated by a code allocation method if a plurality of the unprotected processors needs to fetch the shuffled P2Is in parallel;
allocate the SCIs according to locations generated by the code allocation method if a plurality of the unprotected processors needs to fetch the SCIs in parallel;
generate the shuffled P2I of the P2I by shuffling an identification field and a single or plurality of other fields in the P2I in a random or predefined manner with the P2I formatter,
wherein the P2I formatter generates a shuffled unique identification field with a bit shuffling logic according to random bit-shuffling transformation data and bit shuffling metadata,
wherein the random bit-shuffling transformation data is a single or plurality of indexes selected in a random or predefined manner for shuffling a single or plurality of bits in a single or plurality of fields of the P2I,
wherein the bit shuffling metadata provides description and information about a single or plurality of indexes for shuffling order of bits and/or of P2I fields, and other information and description of the bits and the P2I fields that are shuffled;
generate random bit orders of the P2Is in the P2I formatter on the fly with (1) random bit-shuffling transformation data to configure the bit shuffling logic and produces associated bit and/or field shuffling metadata, including (1) segmentation mode, (2) orders of bits, (3) authentication information, (4) expiration time, etc.,
wherein the bit and/or field shuffling metadata is used for generating a different format of the P2I;
shuffle bits of each P2I to recover bit-orders of the P2I using the transformation information for dynamic retransformation of the P2I formatter; and
generate a shuffled P2I of a P2I by shuffling bits of the P2I in a random or predetermined manner by interfacing a hardware component containing random bit-shuffling transformation data to the P2I formatter including the bit shuffling logic for configuring the bit shuffling logic, translating a P2I format to another format within a single of plurality of instruction cycles, and producing associated bit and/or field shuffling meta data and another hardware component containing bit and/or field shuffling meta data.

7. The P2 processing system of claim 1, wherein the P2 instruction (P2I) set transformation compilation comprising:
a P2 compilation;
a P2 instruction (P2I) set;
a P2 instruction (P2I) code;
a segmented compatible (SC) instruction code;
a protecting resource mappings and management; and
a protection monitor,
wherein the P2I set transformation compilation is operable to:
dynamically recompile a current authorized code to generate a P2I code and a SCI code;
identify random instruction segments in a SCI code as per the selected segmentation mode, which represents a desired level of security, a desired level of performance, and mixed features of security and performance;
transform identified segments to the SCI code by reformatting segments as per the identified P2I set;
generate decoding information to decode shuffled P2Is according to the P2I set;
compile an executable program to produce the P2I code and the SCI code,
wherein the P2I code and the SCI code are for proactively protecting information in computing systems and the computing systems themselves and for producing compatible execution results of the executable program,
wherein an executable program comprises a single or plurality of unprotected instructions (UIs);
produce a single or plurality of P2I sets from an UI set used in the unprotected systems and the executable program,
wherein the P2I set comprises a plurality of P2Is transformed from the UIs used in the executable program; and
determine (1) how many a single UI or a plurality of consecutive UIs is assigned to a P2I for enhancing code security by increasing probability of the possible combinations of different P2Is generated from the single UI or the plurality of consecutive UIs; and (2) how many SCIs are generated from the executable program for controlling different levels of code protections and performance and resources, including instruction memory size, according to characteristics of the executable program and the different types of computing systems.
wherein the P2 compilation is operable to:
create a single or plurality of SCIs from every UI stream in an unprotected executable code with a series of the consecutive P2 compilation when an authorized identification is accepted;
continue operations of the P2 compilation until last segment of the unprotected executable code is compiled;
compile an unprotected code, such as application and system software written in an instruction set, with the P2 compilation at random time intervals;
generate a single or plurality of P2I sets for P2I code compilation;
identify a single or plurality of UIs in an unprotected machine language code to evaluate possible fragment of the P2I;
generate either a plurality of the P2Is and addresses of the P2Is to allocate the P2Is into the P2I memory and a plurality of the SCIs and addresses to allocate the SCIs in the SCI memory or a P2I and addresses of the SCIs;
evaluate possible fragment of the SCIs and fragment either a plurality of the SCIs;
generate a plurality of the fragmented SCIs and the addresses to allocate the fragmented SCIs or iterate the P2 compilation until the P2 compilation is completed;
allocate the P2Is and the SCIs generated to the P2I memory and to the SCI memory, respectively; and
compile a plurality of the P2Is to generate distinguished P2 compilation results from the results of other computing systems for the code security.
wherein the P2I set is operable to:
relocate a single or plurality of bits in a single or plurality of different fields in the P2I set to the same or different locations in the P2I set to generate a plurality of different formats of the P2I sets;
comprise a plurality of P2Is transformed from the UIs used in the executable program;
provide compatible execution results regardless of which P2I set is used for the P2 compilation of the same executable program;
provide a plurality of unique P2I sets dynamically generated and one of the P2I sets randomly switched at random or scheduled time to detect and delete a single or plurality of unauthorized executable programs and access secured information;
provide a mean to authenticate each of the executable programs and information according to the authorized P2I set;
reformat segments as per the identified P2I set for transforming the identified segments to the SCI code;
provide decoding information to the P2I decoder to decode the shuffled P2Is fetched from the P2I fetcher and the P2I cache and memory;
provide an encryption identification to create a protected data file for decrypting the data file when reading data from the file after being protected;
provide a single or plurality of P2I sets for P2I code compilation;
update decoding information generated of P2Is from the P2I set;
switch a P2I set to a different P2I set; and
generate a single or plurality of P2I sets for P2I code compilation.
wherein the P2I code is operable to:
proactively protect information in computing systems built with the P2 processing system and the computing systems themselves;
be generated by compiling UIs in an executable program via the P2 compilation, wherein an executable program comprises a single or plurality of the UIs;
be dynamically recompiled from a current authorized code via the P2I set transformation compilation;
be produced by the P2 compilation for compiling a single or plurality of executable programs;
provide only an authorized code to execute for swiftly resuming scheduled tasks, including detecting, disabling, and deleting an unauthorized code upon admitting into the P2 processing unit hardware;
be used for increasing randomness of P2Is and security capability by reducing control signals and other data encapsulation; and
be forwarded to the P2I formatter for generating random bit-order of P2Is, as shuffled P2Is of the P2Is by shuffling an identification field and a single or plurality of other fields in the P2Is in a random or predefined manner, wherein a shuffled unique identification field is generated by a bit shuffling logic according to random bit-shuffling transformation data and bit and/or field shuffling metadata.
wherein the SCI code is operable to:
proactively protect information in computing systems built with the P2 processing system and the computing systems themselves with the associated P2I code;
be generated by compiling the UIs in the executable program with the associated P2I code via the P2 compilation, wherein the executable program comprises a single or plurality of the UIs;
produce compatible execution results of the executable program with the associated P2I code;
produce compatible results of the UIs while securing code by distinguishing the UI code compiled for common usage from the SCI code compiled for authorized usage with only a single or plurality of authorized computing systems;
produce a single or plurality of the P2I codes and a single or plurality of the SCI codes by compiling a single or plurality of executable programs;
be dynamically recompiled from a current authorized code via the P2I set transformation compilation with the associated P2I code;
be produced by the P2 compilation for compiling a single or plurality of executable programs with the associated P2I code;
provide only an authorized code to execute for swiftly resuming scheduled tasks after detecting, disabling, and deleting an unauthorized code upon admitting into the P2 processing unit hardware;
identify random instruction segments in the SCI code as per the selected segmentation mode, which represents a desired level of security, a desired level of performance, and mixed features of security and performance via the P2I set transformation compilation;
transform the identified segments to the SCI code by reformatting segments as per the identified P2I set via the P2I set transformation compilation;
create a single or plurality of the SCIs from every UI stream in an unprotected executable code via a series of the consecutive P2 compilation when an authorized identification is accepted, wherein the P2 compilation continues until the last segment of the unprotected executable code is compiled; and
provide inputs to the P2I codes and the SCI codes for increasing randomness of P2Is and security capability by reducing control signals and other data encapsulation with the associated P2I code.
wherein the protecting resource mappings and management is operable to:
transmit P2 monitoring information from the protection monitor to synchronize the protection and memory management operations configured with the protection monitor;
receive P2 monitoring information from the protection monitor to synchronize the protection and memory management operations configured with the protection monitor;
configure a single or plurality of computing systems for evaluating the executable programs and information management; and
configure and identify the management and monitoring policies and protocols between the same and different types of computing systems.
wherein the protection monitor is operable to:
handle the operations related to the protecting resource mappings and management alongside the P2 compilation and the P2 data memory system;
provide inputs to the P2I codes and the SCI codes for increasing randomness of the P2Is and security capability by reducing control signals and other data encapsulation;
receive P2 data or non-P2 data from the P2 data memory system for handling protection monitoring and memory management operations, including configuration of a single or plurality of P2 memory zones in the P2 data memory system in terms of (1) different sizes of the P2 data memory zones and non-P2 data memory zones in an unified memory or separated memories, i.e., the P2 data memory and the non-P2 data memory in the P2 data memory system, (2) protection priorities according to worth of the P2 data, usage of the P2 data, and other means, (3) types of protection, including randomness, selection and generation of passcode and encryption, and other means are not limited in its application to the details of construction or to the arrangements of the components in the description;
hold and share the P2 data in the P2 data memory system for identifying protecting resource mappings and management operations;
provide P2 monitoring information to synchronize the protection and memory management operations configured with the protection monitor; and
transmit to and receive from the unprotected processors for producing compatible results of authorized executable codes, storing and utilizing the P2 data, and other means needed for between the unprotected processors and the P2 data memory system.

8. A proactively protected (P2) processing method of proactively protected processing software and hardware for a P2 computing system for cybersecurity, the P2 processing method comprising:
a P2 compiler as a software component operates to:
generate a single or plurality of P2Is stored in a P2I memory via a P2I formatter from unprotected instructions (UIs) compiled by a conventional compiler for a single or plurality of unprotected processors and stored in an UI memory;
generate the SCIs from the P2Is compiled and shuffled, wherein the different SCIs are generated and stored in a SCI memory;
segment as per segmentation modes, including one of a plurality of desired security levels, one of a plurality of desired performance levels, one of a plurality of optimization levels which counts on both security and performance levels, and other desired features used, but not limited;
produce a P2I and a plurality of SCIs from a plurality of UIs, wherein the SCIs must be executed by the unprotected processors in order for saving entries of the P2I memory or produce a plurality of P2Is and a plurality of SCIs from a plurality of UIs for generating distinguished P2 compilation results from the results of other computing systems for the code security;
translate an unconditional flow control UI to a P2I, which is no longer executed by any of the unprotected processors without causing any code compatibility in the P2 computing system;
compile consecutive UIs in a subroutine including a subroutine return UI to a P2I and a plurality of SCIs,
wherein the consecutive UIs in the subroutine is compiled with or without the P2I,
wherein the P2I compiled from the subroutine return UI is not executed by the unprotected processors and is not necessary to store in the P2I memory system;
similarly compile consecutive UIs in an interrupt service routine or an exception service routine including a interrupt service routine return UI or an exception service routine UI to a P2I and a plurality of SCIs,
wherein the consecutive UIs in the interrupt service routine or the exception service routine is compiled with or without the P2I,
wherein the P2I compiled from the interrupt service routine return UI or the exception service routine UI is not executed by the unprotected processors and is not necessary to store in the P2I memory system;
compile an UI, an interrupt service routine call instruction or an exception service routine call instruction, to a P2I,
wherein the P2I compiled from the interrupt service routine call or the exception service routine call UI is executed by the unprotected processors but not necessary to produce an associated SCI and not store in the SCI cache and memory in the P2I memory system;
compile consecutive UIs, including a conditional branch instruction, to a P2I and consecutive SCIs which are executed by the unprotected processors for performing assigned conditional branch operations, wherein the last UI compiled is a conditional branch instruction, which may use a branch prediction unit for predicting branch operation status,
allocate a plurality of the P2Is generated to the P2I memory for fetching the associated SCIs from the SCI memory;
allocate a single or plurality of additional P2Is to the P2I memory for performing the unconditional flow control operations without accessing SCIs by the unprotected processor;
generate different number of the P2Is according to one of the segmentation modes selected, but must be allocated in the same order of a single or plurality of the UIs compiled by the conventional compiler;
allocate a single or plurality of the SCIs generated from a consecutive plurality of UI and a single UI, a plurality of the SCIs generated from a plurality of UIs including a conditional flow control UI, and a single or plurality of the SCIs generated from a single or plurality of UIs in a subroutine to a plurality of different entries, which are not overlapped each other in the SCI memory, in different order of the associated the P2Is stored in the P2I memory;
compile a plurality of UIs in an executable code to a plurality of P2Is and a plurality of associate SCIs, which produce compatible results of a plurality of the UIs with a single or plurality of the unprotected processors, wherein a plurality of the P2Is and a plurality of the associate SCIs executed can be a few number of the UIs to increase performance, reduce processing energy, while securing authorized executable code by distinguishing the UI code compiled for common or unprotected usage from the P2I code and the SCI code compiled for authorized protected usage with a single or plurality of authorized computing systems; and
be not limited in its application to the details of construction or to the arrangements of the components set forth in the above description.
a P2 instruction format operates to:
design a plurality of P2I bit-formats comprising of a plurality of fields, including an ‘X’-bit type of P2I, a ‘Y’-bit memory location of the first SCI in the P2I, and a ‘Z’-bit single or plurality of SCIs associated in the P2I, wherein ‘X’, ‘Y’, ‘Z’, and ‘K’ are positive integers;
design types of P2Is including a type of unconditional or conditional flow control, a subroutine call or return, subroutine, and other different types of P2Is found in prior arts;
design memory location of the first SCI associated with the P2I identified in the field after the P2I code compilation;
design a number of single of plurality of SCIs associated with the P2I identified in the field;
change the P2I format in the specific instruction set and/or the processor designed within the scope of target applications;
do not limit the P2I format in its bit-length of the fields, orders of the fields, and a single or plurality of other fields to the details of construction or to the arrangements of the bits and orders set forth in the above description.
a P2I formatter as a hardware component operates to:
generate bit orders of P2Is compiled through the P2I code compilation on the fly in order to dynamically respond a busting request to migrate another format of an instruction set;
include a bit shuffling logic interfaced to a hardware component containing random bit-shuffling transformation data (1) to configure the bit shuffling logic, (2) to translate current P2I format to another format within a single of plurality of instruction cycles, and (3) to produce associated bit and/or field shuffling meta data;
contain bit and/or field shuffling meta data for generating a ‘K’-bit shuffled P2I of a P2I by shuffling bits of the P2I in a random or predetermined manner with another hardware component;
utilize random bit-shuffling transformation data to configure the bit shuffling logic, which translates the currently used P2I format to another P2I format within a single or plurality of instruction cycles and produces associated bit and/or field shuffling metadata with the bit shuffling logic,
wherein the bit and/or field shuffling metadata includes (1) segmentation mode, (2) orders of bits, (3) authentication information, (4) expiration time, etc.,
wherein the random bit-shuffling transformation data is a single or plurality of indexes selected in a random or predetermined manner for shuffling a single or plurality of bits in a single or plurality of fields of the P2I;
generate a different format of a P2I with the bit and/or field shuffling metadata;
provide description and information about a single or plurality of indexes for shuffling order of bits and/or of fields with the bit and/or field shuffling metadata;
utilize other information and description of bits and/or fields that are shuffled in a P2I; and
do not limited in its application to the details of construction or to the arrangements of the components set forth in the above description.

9. The P2 processing method of claim 8, wherein the P2I and the SCI generation and allocation processes operate to:
format, fragment, generate, and allocate P2Is and SCIs via a P2 code transformation compilation;
identify a single or plurality of instructions in the unprotected machine language code according to the format of the instructions;
fragment the instructions identified to generate a single or plurality of fragmented P2Is and addresses of the fragmented P2Is and an associated single or plurality of the fragmented SCIs and addresses of the fragmented SCIs if needed, otherwise, generate a single or plurality of P2Is and addresses of the P2Is and an associated single or plurality of the SCIs and addresses of the SCIs;
allocate the P2Is to the P2I cache & memory and the SCIs to the SCI cache & memory for serial and/or parallel fetching to a single or plurality of the unprotected processors with the P2I and the SCI allocation process;
allocate the P2Is to the P2I memory and the SCIs to the SCI memory according to addresses generated until the P2 compilation is completed; and
do not limited in its application to the details of construction or to the arrangements of the components set forth in the above description of P2I and the SCI generation and allocation processes.
